(19) United States
(12) Patent Application Publication
(10) Pub. No.: US 2025/0340476 A1
(43) Pub. Date: Nov. 6, 2025

(54) SYSTEM FOR MONITORING AND REGULATING SECTIONS OF A MACHINE FOR FORMING HOLLOW GLASS ARTICLES AND METHOD FOR MONITORING AND REGULATING SECTIONS OF SUCH A MACHINE

(71) Applicant: TECHNICAL MACHINE EQUIPMENT ENGINEERING - T.M.E. ENGINEERING, Arques (FR)

(72) Inventors: Jean-François DE FEUARDENT, Boulogne-sur-Mer (FR); Christophe LAPONCHE, Saint-Omer (FR); Louis-Henri ESCOUBOUÉ, Paris (FR); Raphaël MALVEZIN, Saint-Omer (FR)

(21) Appl. No.: 18/855,437

(22) PCT Filed: Apr. 11, 2023
(86) PCT No.: PCT/FR2023/050522

§ 371 Date: Oct. 9, 2024

(30) Foreign Application Priority Data
Apr. 12, 2022 (FR) FR2203366
Apr. 21, 2022 (FR) FR2203731

(51) Int. Cl. C03B 9/41; C03B 9/38

(52) U.S. Cl. CPC C03B 9/41; C03B 9/3816

(57) ABSTRACT

The invention relates to a system and method for monitoring and regulating sections of a for forming hollow glass articles. Each section includes a parison-forming device forming device includes a device for cooling its two parts. The system includes a processing unit configured to deliver corrective data allowing the cooling devices of the parison-forming devices to be controlled. The system further includes the same number of cameras measuring in the near infrared wavelength (e.g., NIR cameras), which deliver shades of grey measured on the parison-forming moulds. The processing unit includes a database of visual hues corresponding to temperatures defined on the parison-forming devices in an open position. The processing unit delivers corrective data as a function of the shades of grey measured in real time by the NIR cameras on the parison-forming devices in the open position and of at least one reference temperature adjusted on said system.

### TECHNICAL FIELD

The present invention concerns the field of the manufacture of hollow glass items and relates to a system for inspecting and regulating the sections of a machine for forming hollow glass items on an installation for manufacturing hollow glass items and to a process for inspecting and regulating the sections of such a machine.

The aim of the present invention is that of homogenizing the serial production of hollow glass items in order to increase productivity while having an optimized quality and ensuring traceability of defects and causes of abnormal variations during the manufacture of hollow glass items.

### PRIOR ART

An installation for manufacturing hollow glass items, hereinafter referred to as “installation”, conventionally comprises a composition station wherein the raw materials (sand, limestone, sodium carbonate, cullet, recycled glass, etc.) used in the glass composition are mixed according to proportions defined based on the desired type of glass. The installation comprises a furnace wherein the raw material mixture is then poured, said mixture being molten at temperatures generally between 1300° C. and 1550° C. The molten glass is then conveyed by means of channels (referred to as “feeders”) to machines for forming hollow glass items (referred to as “IS machines”) by adjusting the temperature of the molten glass so that it is at a satisfactory working viscosity and at a homogeneous temperature at the time of formation of the glass beads, also known as gobs. Each channel (or feeder) ends with a bowl and a gob formation mechanism which makes it possible to cut the gobs according to a defined weight at throughputs potentially reaching the order of four hundred gobs per minute (400 gobs/minute). The IS machine is composed of several sections, generally varying between six and twelve sections, the gobs at the output of the gob formation mechanism being conveyed to the sections of the IS machine via passages. Each section comprises a parison device allowing the formation of one or more hollow item blanks to be transferred to a finishing device to form one or more finished hollow items. On each section, the parison device may include one or more parison molds for the simultaneous formation of one or more hollow glass items in the blank state and, similarly, the finishing device may include one or more finishing molds for the simultaneous formation of one or more finished glass items. The parison device is composed of two parts, an actuation mechanism for moving the two parts apart to open the parison mold(s) and release the item blank(s) and, conversely, moving said two parts closer together to close the parison mold(s) and form said item blank(s). In the same way, the finishing device is composed of two parts, an actuation mechanism for moving the two parts apart to open the finishing mold(s) and insert the item blank(s) or release the finished item(s) and, conversely, moving said two parts closer together to close the finishing mold(s) and form said finished item(s). The transfer of the item blanks from the parison device to the finishing device is carried out by a hinged transfer arm which takes hold of the item blanks once the parison molds are open and moves them to the open finishing molds, before closing them again for the finishing of the hollow glass items. Each finished hollow glass item is then transferred to a conveyor to be conveyed to a lehr where the hollow glass items undergo controlled cooling to prevent weakening due to overly sudden temperature variations. Installations for manufacturing hollow glass items aimed at improving quality by reducing the quantity of defective hollow glass items are known. This defectiveness may be due to variations of the temperature of the skin of the parison mold capable of causing visual glass defects or critical glass defects. These temperature variations may be caused by fouling of the skin of the parison mold on account of its lubrication in order to prevent the glass from adhering to the skin of the parison mold and facilitate mold release of the item blank. These installations perform glass temperature or thickness measurements on the hollow glass items at the IS machine output, once said items have been placed on the conveyor, prior to conveying them into the lehr. Inspection is carried out by means of infrared radiation-sensitive sensors or an infrared camera. Comparing the measurements made to mathematical models makes it possible to apply a correction upstream from or on the IS machine in order to correct the defects on the finish hollow glass item. Mention will be made for example of patent EP0643297B1 and patent EP1525469B1. It is also known to carry out inspections on the parison devices of the sections of the IS machine. In patent EP2511245B1, it is provided to place fixed pyrometers or fixed thermal cameras and making measurements on all the parison devices of the sections of the IS machines, then perform air-flow cooling of these parison devices; a variant is also provided with a rotary pyrometer mounted on a boat which moves along the IS machine on each of the sections to make measurements on the parison devices. In patent EP0151339B1, an infrared camera is provided, pivotally mounted to alternately perform a temperature measurement on the open parts of a device of a first section then on the open parts of a device of a second section of the IS machine, cooling of these molds being carried out according to the temperature measurements made. Patent application DE102009005433A1 also provides to assign one or two camera per section of an IS machine, these cameras being capable of working in the infrared range.

### SUMMARY OF THE INVENTION

The aim of the present invention is that of implementing a system for inspecting and regulating the parison devices on the sections of an IS machine in order to make a correction of the temperature of the parison mold(s) of these parison devices either to cool them or to heat them by varying the cooling device in order to increase or reduce the flow of a coolant, or interrupt it, with a view to optimizing the quality of the hollow glass items manufactured.

A further aim is that of being able to perform a curative intervention on a parison device of a section of the IS machine in the case of a poor feed of the gob into a parison mold. Indeed, it may occur that the gob does not fall correctly into the feed funnel of a parison mold of the parison device, which may give rise to jamming of said parison mold, its degradation and the onset of a fire, requiring a full shutdown of the IS machine rather than a shutdown only of the relevant section of this IS machine in order to work on this section.

A further aim is that of being able to make in the same way a correction of the temperature of the finishing mold(s) of the finishing device on each of the sections of the IS machine, in order to heat or cool them by varying a cooling device on the finishing device making it possible to increase or reduce the flow of a coolant, or interrupt it, again with a view to optimizing the quality of the hollow glass items manufactured

A further aim is that of reducing the cost of the inspection and regulation system.

A further aim is that of minimizing human intervention on the inspection and regulation system in order to make corrections on it and optimize the measurements made.

These aims are achieved by the invention which implements a process and a system for inspecting and regulating on sections of a machine for forming hollow glass items, referred to hereinafter in the description as IS machine. The invention also relates to an IS machine equipped with such an inspection and regulation system, as well as an installation for manufacturing hollow glass items that is equipped with such an IS machine. Hereinafter in the description, the term “item” refers to a hollow glass item.

An IS machine comprises sections, each section comprising a parison device which includes two parts forming at least one parison mold. These two parts are capable of switching from an open position where they are moved apart in order to open the at least one parison mold and allow the release of the at least one item blank from the parison device, to a closed position where the two parts are joined to form the at least one parison mold and allow the formation of at least one item blank. Indeed, a parison device generally comprises between one and four parison molds to simultaneously form one to four item blanks, this number being capable of being higher, however. Each part of a parison device therefore includes at least one negative of an item blank part, generally one to four negatives, or more. Each of the parison devices comprises a device for cooling the two parison device parts in order to be able to modify the temperature of the parison molds on each parison device. Furthermore, the inspection and regulation system comprises a computer processing unit configured to retrieve corrective data for acting upon the cooling devices of the parison molds in order to vary the temperature of said parison molds according to whether they are heating too much or not enough during item blank formation. According to the invention, the inspection system comprises the same number of cameras for measuring near infrared radiation, referred to as NIR cameras, as sections on the IS machine. These NIR cameras are placed directly on the sections with an orientation facing the parison devices making it possible to view the negatives on the two parts—forming at least one parison mold—of said parison devices in open positions, said NIR cameras retrieving grayscales measured on at least the negatives of the two parts of each parison device. In other words, the NIR cameras are placed on each section between the parison device and the finishing device in order to be oriented facing the opening angle of the two parts of the parison device and thus obtain an optimal view on the at least one parison mold when the parison device is in the open position. Moreover, the processing unit comprises a database of visual colors corresponding to defined temperatures on the parison devices in the open position, said processing unit subsequently retrieving said corrective data according to the grayscales measured in real time by the NIR cameras on the parison devices in the open position and at least one reference temperature set on said inspection system. The real-time grayscale measurements on the parison devices in the open position are compared to the visual colors by the processing unit, allowing it to infer therefrom defined temperatures on the at least one parison mold of the parison devices in the open position, then compare these defined temperatures to the at least one reference temperature in order to infer the corrective data therefrom. The grayscale measurements by the NIR cameras are made on the at least one parison mold of the parison device in the open position, allowing visual colors to be assigned to the at least one negative of the at least one parison mold of each parison device. In addition, these measurements may also be made on at least one plunger of the at least one parison mold on each parison device, then allowing visual colors to be assigned to this at least one plunger of the at least one parison mold of each parison device, the presence of the plunger allowing the formation of the neck of an item blank.

According to the invention, preferably, the computer processing unit is configured to form the visual color database by performing a correlation between the grayscales measured by the NIR cameras on the parison devices in the open position, in particular on the negatives of the parison molds of these parison devices, and a measured actual temperature and by assigning a visual color corresponding to a defined temperature.

According to an embodiment of the inspection and regulation system, the system comprises at least one temperature measurement member, in particular of the pyrometer type, associated with at least one of the parison devices, said at least one temperature measurement member being configured to retrieve an actual temperature at a reference point on the parison device with which it is associated. Moreover, the computer processing unit is configured to perform a correlation between the grayscales measured by the NIR cameras on the parison devices in the open position and the actual temperature measured by the at least one temperature measurement member and assign a visual color to a defined temperature on the parison devices in the open position. The presence of this at least one temperature measurement member is useful for the database acquisition phase; this at least one temperature measurement member may therefore be present on the IS machine during the visual color database acquisition phase, then removed from the IS machine. This at least one temperature measurement member may also be left on the section permanently in order to remedy drifts of the inspection and regulation system over time, for example on account of the season which affects the brightness and the ambient temperature, in particular, and thus make corrective updates to the database. The temperature measurement member is preferably a pyrometer; variants are however possible with temperature measurement means other than a pyrometer, for example a thermocouple or other temperature probes. The inspection and regulation system may optionally comprise several temperature measurement members, in particular of the pyrometer type, respectively retrieving actual temperatures at a reference point on parison devices with which they are associated. In this case, the computer processing unit is configured to perform a correlation between the grayscales measured by the NIR cameras and the actual temperatures measured by said temperature measurement members and assign a visual color to a defined temperature on the parison devices in the open position. In other words, the actual temperature measured by a temperature measurement member associated with a first parison device will serve to assign a visual color to a defined temperature on at least the negatives of the parison molds of one or more parison devices, of which said first parison device, and the actual temperature measured by a temperature measurement member associated with a second parison device will serve to assign a visual color to a defined temperature on at least the negatives of the parison molds of one or more parison devices, of which said second parison device, and so on according to the number of temperature measurement members associated respectively with parison molds. Thus, according to this embodiment, the inspection and regulation system may comprise a number of temperature measurement members between two and half of the number of sections on the IS machine, the temperature measurement members being distributed on the respective parison devices between a central section and an end section on the IS machine.

According to another possible embodiment of the inspection and regulation system, the latter may comprise the same number of temperature measurement members as NIR cameras, the temperature measurement members respectively retrieving actual temperatures at a reference point on parison devices with which they are associated. Furthermore, the computer processing unit is configured to perform a correlation between the grayscales measured by the NIR cameras and the actual temperatures measured by the temperature measurement members and assign a visual color to a defined temperature on at least the negatives of the parison devices of said parison devices. In other words, the actual temperature measured by a temperature measurement member associated with a parison device will serve to assign a visual color to a defined temperature on the at least one negative of the at least one parison mold of this parison device, and so on respectively for all the temperature measurement members associated with the parison devices.

Each of said parison devices comprises at least one plunger and a device for cooling the at least one plunger. The number of plungers depends on the number of parison molds present on the parison device. According to an embodiment of the inspection and regulation system, the computer processing unit is configured to retrieve corrective data for acting upon the devices for cooling the plunger(s) present on each of said parison devices. The NIR cameras also make it possible to view the at least one plunger between the two parison device parts in the open position and retrieve grayscales measured on said at least one plunger. Furthermore, the processing unit comprises a database of visual colors corresponding to defined temperatures on the plungers of the parison devices in the open position, said processing unit being configured to subsequently retrieve said corrective data for the device for cooling the plungers according to the grayscales measured in real time by the NIR cameras on the plunger(s) of the parison device(s) in the open position and a reference temperature set on said inspection system. In this case, the computer processing unit is configured to form the visual color database by performing a correlation between the grayscales measured by the NIR cameras on the plungers of the parison molds of the parison devices in the open position and a measured actual temperature and by assigning a visual color corresponding to a defined temperature. Preferably, the actual temperatures measured are obtained by means of at least one temperature measurement member associated with at least one of the parison devices, these actual temperatures being measured at a reference point on the parison device, which, in this case, may be one of the plungers of a parison mold on the parison device.

According to an embodiment of the inspection and regulation system, the computer processing unit is configured to analyze the grayscales measured by the NIR cameras and detect an abnormally high and prolonged temperature representative of an anomaly on the parison device, said processing unit emitting an item of alert and/or emergency shutdown information in respect of the section in question. It may in particular occur that a gob falls next to a funnel on a parison mold of a parison device, with a hot spot and an accumulation of molten glass occurring on the parison device, around the funnel of the parison mold. The inspection and regulation system therefore makes it possible to detect such an anomaly and stop the gob supply of the relevant section of the IS machine, in order to work on this section. According to an embodiment of the inspection and regulation system, at least one temperature measurement member, in particular of the pyrometer type, is associated with the NIR camera and measures the actual temperature at a reference point on the negative of a parison mold of a parison device or on a plunger of said parison mold. This makes possible to use a point of the parison device having an influence on the quality of the item blank and which needs to be controlled in terms of temperature during manufacture as reference point. Further embodiments could provide a temperature measurement member taking a reference point elsewhere on the parison device, or a temperature measurement member arranged on one of the outer faces of one of the parts of the parison device. Preferably, the temperature measurement member is a pyrometer; the pyrometer could however be replaced by other temperature measurement means, for example a temperature probe placed on the parison device at a defined point.

Each section of the IS machine comprises a finishing device which includes two parts forming at least one finishing mold and is capable of switching from an open position where the two parts are moved apart to position at least one item blank or remove at least one finished item, to a closed position where the two parts are joined for the formation of at least one finished item. Each of said finishing devices comprises a device for cooling said parts. Furthermore, according to an embodiment of the inspection and regulation system, the computer processing unit is configured to retrieve corrective data making it possible to act upon the devices for cooling the finishing devices, said inspection system comprising the same number of second cameras for measuring near infrared radiation, referred to as NIR cameras, as sections on the IS machine. The second NIR cameras are placed directly on the sections with an orientation facing the finishing devices making it possible to view the negatives of the parts of the finishing devices in the open position, said second NIR cameras retrieving grayscales measured on the negatives of the two parts of the finishing molds. In other words, the second NIR cameras are placed on each section on the side of the finishing device in order to be oriented facing the opening angle of the two parts of the finishing device and thus obtain an optimal view on the at least one finishing mold when the finishing device is in the open position. Moreover, the processing unit comprises a database of visual colors corresponding to defined temperatures on the finishing devices in the open position. Furthermore, the processing unit is configured to subsequently retrieve corrective data according to the grayscales measured in real time by the second NIR cameras on the finishing devices and at least a second reference temperature set on said inspection system. In order words, the inspection and regulation system is designed in such a way that its technical features implemented mainly for the parison devices of the IS machine are duplicated to be implemented also for the finishing devices, except that the finishing molds of the finishing devices, observed by the second NIR cameras, have no plungers. According to the invention, preferably, the computer processing unit is therefore, additionally, configured to form the visual color database by performing a correlation between the grayscales measured by the second NIR cameras on the finishing devices in the open position, i.e. on the negatives of the finishing molds of these finishing devices, and a measured actual temperature and by assigning a visual color corresponding to a defined temperature.

According to an embodiment of the inspection and regulation system, the system comprises at least a second temperature measurement member, in particular of the pyrometer type, associated with at least one of the finishing devices, said at least a second temperature measurement member being configured to retrieve an actual temperature at a reference point on the finishing device with which it is associated. Moreover, the computer processing unit is configured to perform a correlation between the grayscales measured by the second NIR cameras on the finishing devices in the open position and the actual temperature measured by the at least a second temperature measurement member and assign a visual color to a defined temperature on the finishing devices in the open position. The presence of this at least a second temperature measurement member is useful only for the database acquisition phase; this at least a second temperature measurement member may therefore be present on the IS machine during the visual color database acquisition phase, then removed from the IS machine. This at least a second temperature measurement member may also be left on the section permanently in order to remedy drifts of the inspection and regulation system over time, for example on account of the season which affects the brightness and the ambient temperature, in particular, and this provide corrective updates to the database. Preferably, the second temperature measurement member is a pyrometer; variants are however possible with temperature measurement means other than a pyrometer, for example a thermocouple or other temperature probes.

According to an embodiment of the inspection and regulation system according to the invention, each NIR camera comprises a housing equipped with a shutter for protecting a lens of said NIR camera. This makes it possible to prevent fouling of the lens on account of the dust and grease present in the environment of the sections of the IS machine. According to an embodiment of the inspection and regulation system, the computer processing unit is configured to control a device for ejecting the hollow glass items at the output of the sections of the IS machine when retrieving corrective data. Retrieval of a corrective data item is representative of a defect on the item according to the correction. The IS machine therefore makes it possible to track this defective item at the section output and its discharge into a recycling bin, also referred to as recycling bunker.

According to an embodiment of the inspection and regulation system according to the invention, the NIR cameras are configured to also view the at least one item blank between the two parts of each parison device in the open position and retrieve grayscales measured on said at least one item blank. Furthermore, the processing unit comprises a database of visual colors corresponding to defined temperatures on the at least one item blank, said processing unit being configured to subsequently retrieve said corrective data for the device for cooling the corresponding parison device according to the grayscales measured in real time by the NIR cameras (30) on the at last one item blank and a reference temperature set on said inspection system.

According to an embodiment of the inspection and regulation system according to the invention, the NIR cameras are configured to additionally retrieve images of the parison devices and their respective environments in the visible range. Furthermore, the computer processing unit of said system is configured to compare these images acquired in the visible range to a reference image database and perform an automatic inspection of the shapes/images of the parison device in order to detect anomalies and trigger a shutdown of the section in question on the IS machine. The system may comprise a digital interface allowing viewing of said images acquired in the visible range, by an operator. NIR camera use offers this advantage of being able to view images in the visible range, i.e. having a wavelength between 0.4 μm and 0.7 μm, and also grayscales, i.e. wavelengths between 0.7 μm and 1 μm.

The invention also relates to a machine for forming hollow glass items, referred to as IS machine, which comprises sections which each include a parison device and a finishing device, the parison device comprising two parts forming at least one parison mold which has a negative and a plunger. These parts of the parison device are capable of switching from an open position where the two parts are moved apart and the at least one parison mold is open, to a closed position where the two parts are joined and the at least one parison mold is closed. The finishing device also comprises two parts forming at least one finishing mold which has a negative, said parts of the finishing device are capable of switching from an open position where the two parts are moved apart and the at least one finishing mold is open, to a closed position where the two parts are joined and the at least one finishing mold is closed. Each of said parison devices comprises a device for cooling its two parts and a device for cooling the at least one plunger. Similarly, each of said finishing devices comprises a device for cooling its two parts, said IS machine comprising an inspection and regulation system having one and/or the other of the abovementioned features according to the invention.

According to an embodiment of the IS machine, each cooling unit comprises a flap for varying a cool air flow generated by a fan, the computer processing unit managing the activation of said flap for varying the cool air flow according to the corrective data supplied by said processing unit.

According to an embodiment of the IS machine, the machine comprises a device for ejecting the glass items manufactured, the computer processing unit being configured to activate said ejection device when corrective data are sent and representative of a potential manufacturing defect of the hollow glass item.

The invention also relates to an installation for manufacturing hollow glass items, which comprises an IS machine having one and/or the other of the abovementioned features.

The invention also relates to an inspection and regulation process of the sections of an IS machine, each section comprising a parison device which includes two parts forming at least one parison mold, said two parts being capable of switching from an open position where they are moved apart in order to open the at least one parison mold and allow the release of the at least one item blank from said at least one parison mold, to a closed position where the two parts are joined to form the at least one parison mold and allow the formation of at least one item blank, each of said parison device comprising a device for cooling its two parts. According to the invention, the process comprises:
a step SD of measuring in real time the grayscales on each parison device in the open position by means of the NIR cameras placed directly on the sections with an orientation making it possible to view the at least one negative of the at least one parison mold of the parison device in the open position, i.e. with an orientation of the NIR camera facing the opening angle of the two parts of the parison device in the open position, said NIR camera being positioned between said parison device and the finishing device on the section of the IS machine, and of computing corrective data by comparing visual colors corresponding to said grayscales to at least one reference temperature, said visual colors being assigned to defined temperatures and obtained from a database;
a step SE of activating the devices for cooling the parison devices according to the corrective data.

According to the invention, the process comprises prior steps of acquiring the database of visual colors corresponding to defined temperatures on the parison devices in the open position. For this, the process comprises at least:
a step SA of acquiring the grayscales measured on the negatives of the two parts of each parison device in the open position by NIR cameras placed directly on the sections with an orientation making it possible to view the negatives of the two parts of the parison device in the open position;
a step SC of correlation between the grayscales measured by the NIR cameras and at least one measured actual temperature and assigning a visual color to a defined temperature on the parison devices, in particular on the at least one negative of the at least one parison mold on said parison devices.

Preferably, these prior steps of acquiring said database comprise a step SB of acquiring the at least one actual temperature at a reference point on at least one of the parison devices, said at least one actual temperature being measured by at least one temperature measurement member, in particular of the pyrometer type, associated with said parison device, simultaneously with the step SA. This at least one temperature measurement member is only useful during the database acquisition phase; this at least one temperature measurement member may therefore be present on the IS machine during the visual color database acquisition phase, then be removed from the IS machine. Conversely, at least one temperature measurement member may be left to make corrections to the database, as explained above. Several temperature measurement members, in particular of the pyrometer type, may optionally respectively retrieve actual temperatures at a reference point on several parison devices with which they are associated, as mentioned above. In this case, the step SB carries out the acquisition of actual temperatures at a reference point on several of the parison devices by means of several temperature measurement members associated with said parison devices, and the step SC carries out a correlation between the grayscales measured by the NIR cameras and the actual temperatures measured by said temperature measurement members and assigns a visual color to a defined temperature on said parison devices, in particular on the at least one negative of the at least one parison mold on each of said parison devices. According to a possible embodiment, the step SB carries out the acquisition of actual temperature on two to half of the number of sections on the IS machine, between a central section and an end section on said IS machine. According to another possible embodiment, the step SB carries out the acquisition of the actual temperatures at a reference point on all the parison devices by means of temperature measurement members associated with the parison devices, and the step SC carries out a correlation between the grayscales measured by the NIR cameras and the actual temperatures measured by the temperature measurement members and assigns a visual color to a defined temperature on the parison devices, in particular on the at least one negative of the at least one parison mold of each of said parison devices.

According to an embodiment of the process:
the step SA additionally carries out the acquisition of the grayscales measured on at least one plunger of at least one parison mold of the parison device in the open position on each of said parison devices by means of said NIR cameras;
the step SC additionally carries out a correlation between the grayscales measured on the at least one plunger on each of the parison devices and the at least one measured actual temperature and assigning of a visual color to a defined temperature on the at least one plunger of the parison devices;
the step SD additionally measures in real time grayscales on the at least one plunger of at least one parison mold on each of the parison devices by means of the NIR cameras and computes corrective data by comparing visual colors corresponding to said grayscales to at least one reference temperature, said visual colors being assigned to defined temperatures and obtained from the database;
the step SE additionally activates devices for cooling the plungers on the parison devices according to the corrective data.

According to an embodiment of the process, the process comprises a step of analyzing the grayscales measured by the NIR cameras and detecting an abnormally high and prolonged temperature representative of an anomaly on the parison device, and a step of emitting an item of alert and/or emergency shutdown information in respect of the section in question.

According to an embodiment of the process, the process implements additional and similar steps to steps SA, SB, SC, SD and SE for the inspection and regulation of the finishing devices on the sections of the IS machine, by means of second NIR cameras configured to view said finishing devices in the open position and optionally by means of at least one second temperature measurement member, in particular of the pyrometer type, measuring the actual temperature a reference point on at least one of the finishing devices, during the step of acquiring the database. According to an embodiment of the process, the process comprises a step of ejecting the glass items at the output of the sections of the IS machine when corrective data are retrieved for the devices for cooling the parison devices. This ejection step will also take into consideration the corrective data retrieved for the devices for cooling the plungers and/or the device for cooling the finishing devices, when such corrections are also made by the process according to the invention.

According to an embodiment of the process according to the invention, the process additionally comprises a step of measuring in real time the grayscales on at least one item blank present on each parison device in the open position by means of the NIR cameras and computing corrective data by comparing visual colors corresponding to said grayscales of the item blanks to at least one reference temperature, said visual colors being assigned to defined temperatures and obtained from the database. This step of the process may be carried out simultaneously with the step SD.

### BRIEF DESCRIPTION OF THE FIGURES

The features and advantages of the invention will become apparent on reading the following description based on the figures, wherein:

FIG. 1 schematically represents an installation for manufacturing hollow glass items implementing the invention;

FIG. 2 illustrates three successive steps of manufacturing an item blank on the parison device;

FIG. 3 illustrates the transfer of an item blank from the parison device to the finishing device;

FIG. 4 illustrates three successive steps of manufacturing the item on the finishing device.

FIG. 5 illustrates an IS machine according to a first viewing angle, on which the inspection and regulation system according to the invention is implemented;

FIG. 6 illustrates the IS machine of FIG. 5 according to a second viewing angle;

FIG. 7 partially illustrates a section of the IS machine in a side view;

FIG. 8 partially illustrates a section of the IS machine with the parison device in the open position, the item blanks having been transferred from the side of the finishing device which is partially represented in order to view said item blanks;

FIG. 9 partially illustrates a section of the IS machine with the parison device represented partially in order to view the plungers, the finishing device being open before transferring the items to the conveyor;

FIG. 10 illustrates an NIR camera with which a pyrometer type measurement member is associated, mounted on the structure of the IS machine;

FIG. 11 schematically represents a first layout variant of pyrometer type temperature measurement members on the IS machine comprising six sections;

FIG. 12 schematically represents a second layout variant of pyrometer type temperature measurement members on the IS machine comprising six sections;

FIG. 13 schematically represents a third layout variant of pyrometer type temperature measurement members on the IS machine comprising six sections;

FIG. 14 schematically represents a flow chart of the steps of compiling a database of visual colors assigned to defined temperatures on the parison devices;

FIG. 15 schematically represents steps of retrieving corrective data according to the grayscales measured in real time by the NIR cameras on the parison devices and at least one reference temperature set on said inspection system;

FIG. 16 schematically represents a graphic interface of the inspection and regulation system showing an operating status of all the sections of the IS machine;

FIG. 17 schematically represents a graphic interface of the inspection and regulation system showing the parameter setting options on a section of the IS machine;

FIG. 18 schematically represents a graphic interface of the inspection and regulation system showing the NIR camera calibration options on the parison devices of the sections of the IS machine.

### DETAILED DESCRIPTION

Hereinafter in the description, unless specified otherwise: the same references are used to denote the same features and according to the various variants illustrated; the machine for forming hollow glass items is referred to as “IS machine”; the hollow glass item is referred to as “item”; the inspection and regulation system according to the invention is referred to as “system”, the inspection and regulation process is referred to as “process”; the cameras for measuring near infrared radiation are referred to as “NIR cameras”; and the installation for manufacturing hollow items is referred to as “installation”.

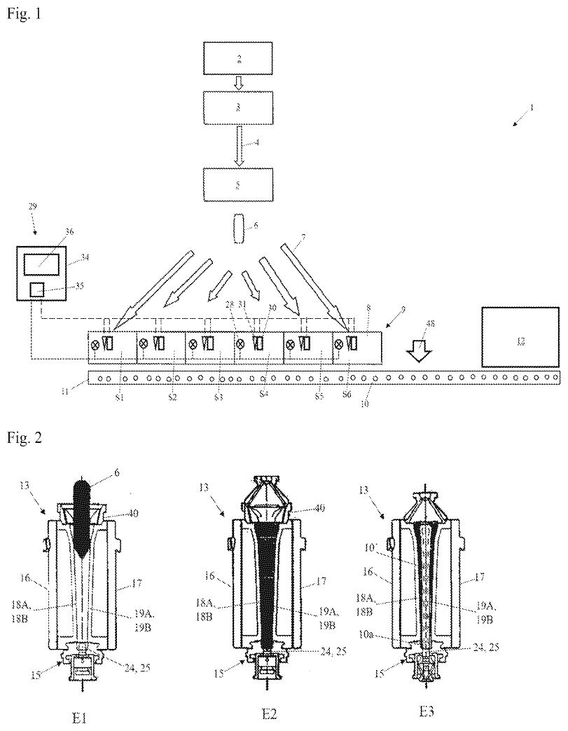

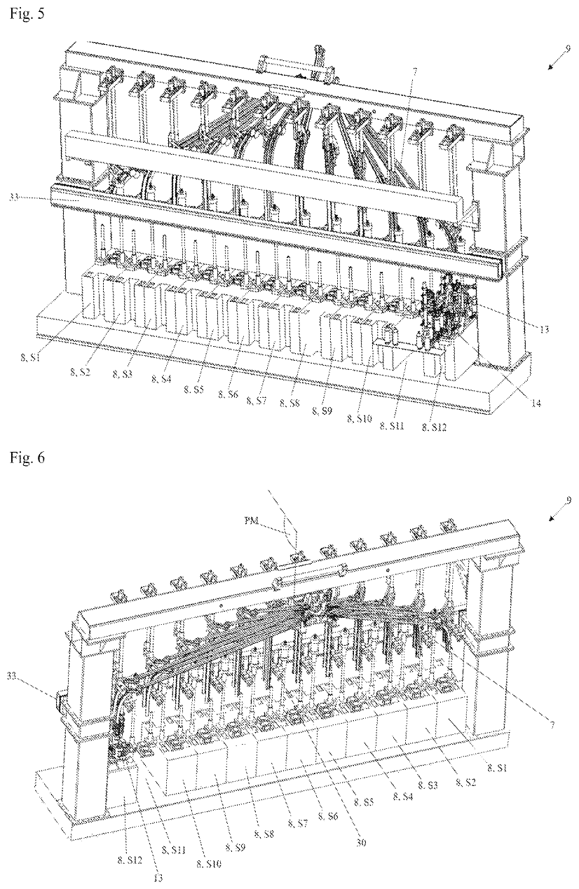

With reference to FIG. 1, the installation 1 comprises a composition station 2 where the raw materials (sand, limestone, sodium carbonate, cullet, recycled glass, etc.) used in the glass composition are mixed, a furnace 3 for melting the raw material mixture, the molten glass obtained being at a temperature of the order of 1300° C. to 1550° C. This molten glass is then conveyed by means of a channel 4 which ends with a mechanism 5 for forming gobs 6 and dispensing these gobs 6 in passages 7 respectively feeding gobs 6 to the sections 8 of an IS machine 9. The number of passages 7 is proportional to the number of sections 8 on the IS machine 9 and to the number of items 10 manufactured simultaneously on a section 8. The items 10 are then transferred from the sections 8 to a conveyor 11 which conveys said items 10 to a lehr 12 for their controlled cooling. The number of sections 8 on the IS machine 9 may vary. For example, six sections 8A to 8F are represented schematically in FIG. 1, whereas the IS machine 9 in FIGS. 5 and 6 comprises twelve sections 8A to 8L (partially illustrated in these FIGS. 5 and 6). The number of sections 8 on the IS machine 9 may be eight or ten, or another number.

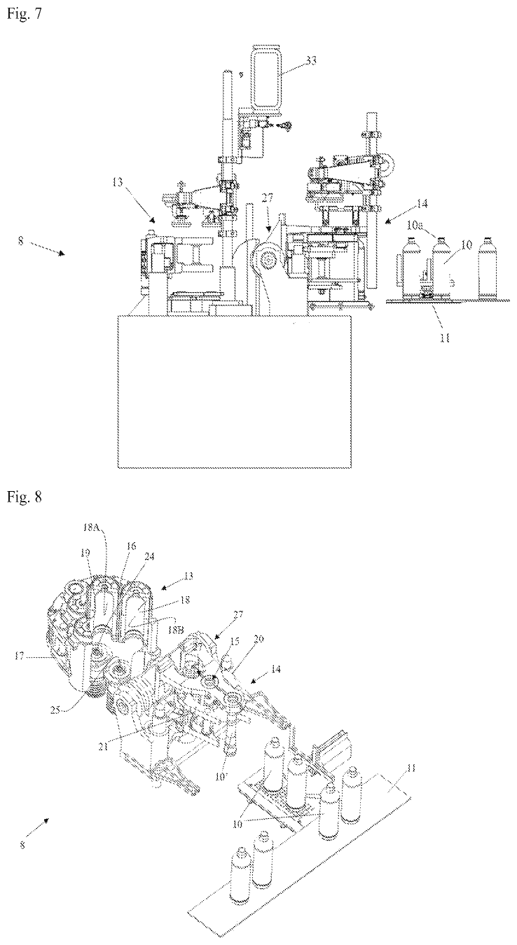

With reference in particular to FIGS. 7 to 9, each section 8 comprises a parison device 13 allowing the formation of two item blanks 10′ and a finishing device 14 allowing the formation of two items 10 with their definitive shape. Each section 8 also comprises a ring mold 15 which allows the formation of the ring 10a of the item 10 and also holds the two item blanks 10′ during their transfer from the parison device 13 to the finishing device 14.

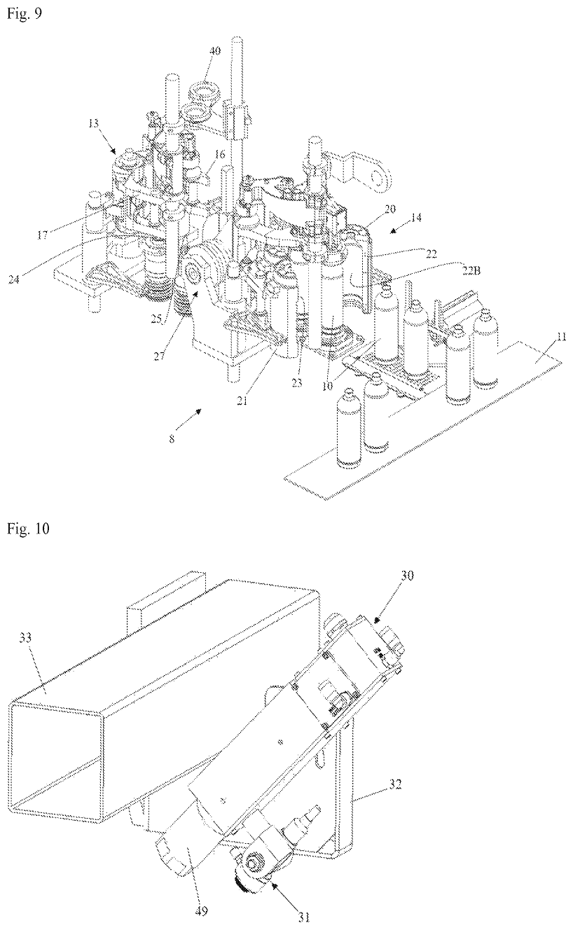

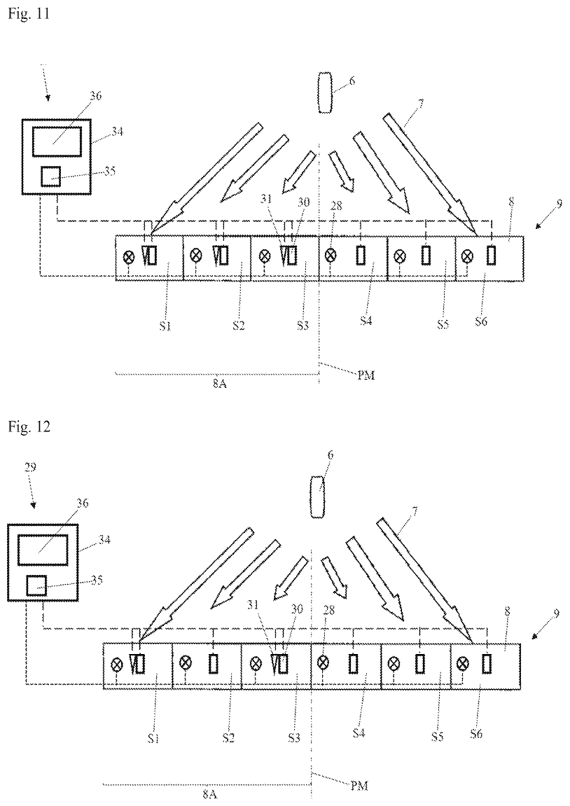

With reference to FIGS. 8, 9 and 17, the parison device 13 comprises two parts 16, 17 which each comprise a cavity 18, 19 on their inner faces. Each of the two cavities 18, 19 comprises two negatives 18A, 18B, 19A, 19B forming two parison molds. When the parison device 13 is in the closed position (FIG. 9), the two parts 16, 17 are combined, which makes it possible to join the two negatives 18A, 19A and the two negatives 18B, 19B to form the negatives of two parison molds allowing the production of two item blanks 10′. Conversely, when the parison device 13 is in the open position (FIG. 8), the two parts 16, 17 are moved apart to open the two parison molds and release the negatives 18A, 18B, 19A, 19B of the two item blanks 10′ held by the ring mold 15, thus making it possible to transfer said item blanks 10′ to the finishing mold 14.

In the same way, with reference to FIGS. 8, 9 and 17, the finishing device 14 comprises two parts 20, 21 which each comprise a cavity 22, 23 on their inner faces. Each of the two cavities 22, 23 comprises two negatives 22A, 22B, 23A, 23B forming two finishing molds. When the finishing device 14 is in the closed position (FIG. 8), the two parts 20, 21 are combined, which makes it possible to join the two negatives 22A, 23A and the two negatives 22B, 23B to form the negatives of two finishing molds allowing the production of two items 10. Conversely, when the finishing device 14 is in the open position (FIG. 9), the two parts 20, 21 are moved apart to open the two finishing molds and release the negatives 22A, 22B, 23A, 23B in order to allow either the positioning of the item blanks 10′ in the finishing device 14 or the removal of the items 10 from said finishing device 14.

The parison device 13 and the finishing device 14 of each section 8 allow in the example described the production of two items 10 simultaneously, the cavities 18, 19 of the parison device 13 and the cavities 22, 23 of the finishing device 14 could however include a different number of negatives in order to allow the formation of a different number of parison molds and finishing molds, for example to form one to four item blanks 10′ on said parison device 13 and one to four items 10 on said finishing device 14.

With reference to these FIGS. 8, 9 and 17, the parison device 13 also comprises two plungers 24, 25 placed respectively at the center, i.e. on the mold joint between the two parts 16, 17 of said parison device 13 when the latter is in the closed position, corresponding with the negatives 18A, 18B, 19A, 19B on the cavities 18, 19. The number of plungers depends on the number of negatives of item blanks 10′ on the parison device 13 and form with them the parison molds on said parison device 13.

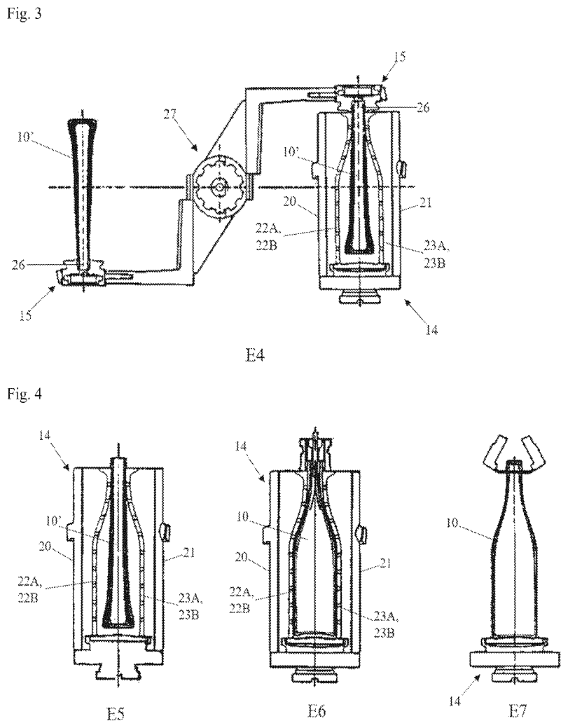

FIGS. 2 to 4 explain the steps of forming an item 10 from the insertion of the gob 6 into a parison mold of the parison device 13 to its output from a finishing mold of the finishing device 14. FIG. 2 shows the successive steps E1, E2, E3 of loading the gob 6, compression and perforation carried out in one of the negatives (combination of the negative parts 18A-19A or 18B-19B) of item blanks 10′. During these successive steps of FIG. 2, the ring mold 15 and the plunger 24, 25 make it possible to fully form the ring 26 directly on the item blank 10′. FIG. 3 shows the step E4 of transferring the item blank 10′ to the finishing device 14, carried out by means of the ring mold 15 which holds the item blank 10′ by the ring 26 and moves thanks to a transfer arm 27 on the finishing device 14. FIG. 4 shows the successive steps E5, E6, E7 of lengthening, blowing and extracting the item 10 which is subsequently transferred to the conveyor 11 (FIG. 1). During steps E1, E2, E3, the negatives 18A, 18B, 19A, 19B of the cavities 18, 19 and the plungers 24, 25 on the parison device 13 heat in contact with the molten glass during the formation of the two item blanks 10′, their temperatures being capable of degrading the quality of the item blanks 10′ when they are too high or, conversely, too low. In the same way, during steps E5, E6, E7, the negatives 22A, 22B, 23A, 23B of the cavities 23, 23 on the finishing device 14 heat in contact with the item blanks 10′ during the formation of the items 10, their temperatures being capable of degrading the quality of the items 10 when they are too high or, conversely, too low, although the risks are lower than during the formation of the item blanks 10′. The parison device 13 comprises a cooling device (not illustrated) which comprises a fan for creating an air flow the flow rate of which may be modified independently on the sections 8 by setting the flaps 28 (represented schematically in FIGS. 1, 11, 12, 13), such that the variable-flow rate air flows on the parison devices 13 of the sections 8 cool the negatives 18A, 18B, 19A, 19B of the cavities 18, 19 of said parison devices 13. Similar cooling devices are also provided for the plungers 24, 25 and for the negatives 22A, 22B, 23A, 23B of the cavities 22, 23 of the finishing devices 14, on the sections 8. Further cooling devices could be provided for the parison devices 13 and the finishing devices 14, by providing an internal cooling circuit wherein the liquid or gas coolant flows.

The system 29 according to the invention makes it possible in particular to act upon the flaps 28 of the cooling device in order to vary the temperatures of the cavities 18, 19 of the parison devices 13. Preferably, the system 29 also makes it possible to act upon the flaps (not illustrated) of the cooling device of the plungers 24, 25 on each section 8 in order to vary their temperatures. Preferably, the system 29 also makes it possible in particular to act upon the flaps (not illustrated) of the cooling device in order to vary the temperatures of the cavities 22, 23 of the finishing devices 14. The following description explains the implementation of the system 29 and the process for the parison devices 13, not only for cooling the negatives 18A, 18B, 19A, 19B of the cavities 18, 19 and, preferably, also for cooling the plungers 24, 25. This description may be applied by similarity to the finishing devices 14.

In FIG. 1, the system 29 comprises six NIR cameras 30 which are installed respectively on the six sections S1 to S6, these NIR cameras 30 make it possible to view grayscales, working in wavelengths between 0.7 μm and 1 μm. Similarly, the system 29 comprises six pyrometers 31 which are installed respectively on the six sections S1 to S6. With reference to FIG. 11, the pyrometer 31 and the NIR camera 30 are combined on the same support 32 which is attached to a structure 33 of the IS machine 9. On each section S1 to S6, the NIR camera 30 and the pyrometer 31 are placed between the parison device 13 and the finishing device 14 and oriented toward the parison device 13 so as to be able to view the cavities 18, 19 of the two parts 16, 17 of said parison device 13 in the open position, as well as the two plungers 24, 25 once the ring mold 15 is moved by the transfer arm 27 toward the finishing device 14. Thus, the NIR camera 30 and the pyrometer 31 are placed facing the opening angle of the two parts 16, 17 of the parison device 13 and view perfectly the two parison molds formed by the negatives 18A, 19A, 18B, 19B and the plungers 24, 25. The NIR camera 30 is used to view grayscales of the cavities 18, 19 of the two parts 16, 17 and also of the two plungers 24, 25. The pyrometer 31 is directed to measure an actual temperature at a reference points either of one of the cavities 18, 19 of the parts 16, 17 or of one of the plungers 24, 25. Preferably, the pyrometer 31 is directed to measure the actual temperature TR of one of the plungers 24, 25. Alternatively, the pyrometer 31 could be separated from the NIR camera 30 and placed directly on the parison device 13 and oriented toward a reference point on one of the cavities 18, 19 of said parts 16, 17 or the plunger 25 located to the front of the parison device 13, or oriented toward a point on an outer wall of one of said parts 16, 17. The pyrometer 31 could also be replaced by another temperature measurement member on the parison device 13, for example a temperature probe placed on one of the parts 16, 17 of the parison device 13.

The system 29 comprises a processing unit 34 which includes in particular a microprocessor 35 programmed to compile a database of visual colors to which defined temperatures TD are assigned for each of the sections 8 of the IS machine 9. For this, the microprocessor 35 provides a calibration phase P1, represented schematically in FIG. 14, implementing a first step SA of acquiring the grayscales measured on the cavities 18, 19 of the two parts 16, 17 in the open position and, preferably, also on the plungers 24, 25, for each parison device 13, by means of the NIR cameras 30. Simultaneously with this first step SA, the calibration phase P1 provides a second step SB of acquiring the actual temperatures measured by the pyrometers 31 at a reference point, preferably on one of the plungers 24, 25 or on one of the cavities 18, 19 of the parts 16, 17 of the parison devices 13 in the open position. In a third step SC, the microprocessor 35 performs a correlation (SC1) between the grayscales measured by the NIR cameras 30 and the actual temperatures TR measured by the pyrometers 31 on each of the sections 8 of the IS machine 9, the microprocessor 35 assigning (SC2) a visual color to a defined temperature TD on the cavities 18, 19 of the parts 16, 17 of the parison devices 13 and, preferably, also on the plungers 24, 25 of said parison devices 13, the microprocessor 35 then saving (SC3) said data in the database. This calibration phase P1 is carried out on a pilot run of items 10, the pyrometers 31 no longer being necessary during the normal operation of the IS machine 9. The pyrometers 31 may however be kept in position on the sections 8 of the IS machine 9 in order to be able to make corrective updates to the database with a view to remedying drifts of the system 29 over time, such drifts being capable of occurring according to the conditions of use and/or the environment of the IS machine 9, for example on account of the season affecting in particular the brightness of the ambient temperature. Furthermore, the measurements of the grayscales by the NIR cameras 30 and the measurements of the actual temperatures TR by the pyrometers 31 are carried out at a specific and regular time on each section 8, preferably at the start of the transfer of the item blank 10′ of the parison device 13 toward the finishing device 14 on each section.

In the case of FIG. 1 where each section S1 to S6 comprises a pyrometer 31, each grayscale measurement by means of the NIR camera 30 is representative of the actual temperature TR measured on the parison device 13 for each section S1 to S6, the defined temperature TD assigned to the visual color then corresponding specifically to the actual temperature TR at the time when said measurements are made. Variants are however possible within the scope of the invention, as illustrated by FIGS. 11 to 13.

In FIG. 11, only a first half 8A of the sections 8 from an end section S1 to a central section S3 is equipped with pyrometers 31, all the sections S1 to S6 remaining equipped with the NIR cameras 30. The passages 7 dispensing the gobs 6 in the parison devices 13 and the sections S1 to S6 being arranged symmetrically relative to a median plane PM of the IS machine 9, the microprocessor 35 of the processing unit 34 is programmed to assign the same defined temperature TD6 to a visual color obtained from a grayscale measurement on the section S6, as the defined temperature TD1 assigned to a visual color obtained from grayscale measurement on the section S1, on the same operating cycle of the machine and at the time of transfer of the item blank 10′ from the parison device 13 to the finishing device 14 on the sections SI and S6 in question. The same applies between the sections S2 and S5 and between the sections S3 and S4. Obviously, the pyrometers 31 could be arranged on the sections S4 to S6 instead of the sections S1 to S3, with a similar result. Obviously, the principle would remain the same with a different number of sections, as for the sections S1 to S12 on the IS machine 9 of FIGS. 5 and 6, the sections S1 to S6 being arranged symmetrically with the sections S7 to S12, relative to a median plane PM.

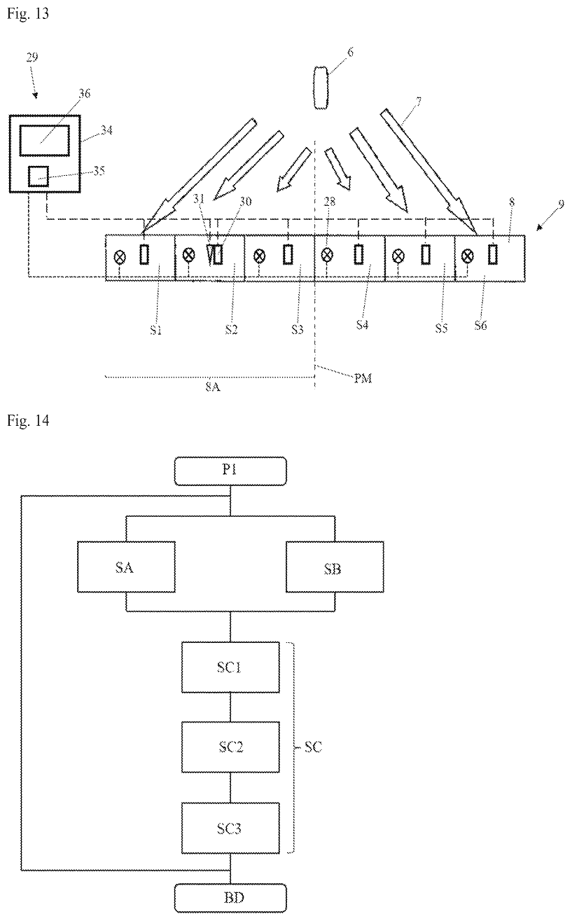

In FIG. 12, only certain sections on a first half 8A of the sections 8 from sections S1 to S3 are equipped with pyrometers 31, all the sections S1 to S6 being equipped with an NIR camera 30. Preferably, as represented schematically in this FIG. 13, two pyrometers 31 are arranged on the parison devices 13 of the end section S1 and the central section S3, making it possible to assign two defined temperatures TD1 and TD3 to the visual colors obtained from the grayscale measurements on the sections S1 and S3 during the same operating cycle of the machine and at the time of transfer of the item blank 10′ from the parison device 13 to the finishing device 14 on the sections S1 and S3 in question. Then, the microprocessor 35 infers therefrom the defined temperature TD2 assigned to the visual color obtained from the grayscale measurement on the section S2 during the same operating cycle of the IS machine 9 and at the time of transfer of the item blank 10′ from the parison device 13 to the finishing device 14 on this section S2, considering that the actual temperature evolves linearly between the section S1 and S3 on account of the length variation of the passages 7 supplying these sections S1 to S3. On the same principle as for FIG. 11, the microprocessor 35 is programmed to subsequently assign the same defined temperatures TD4, TD5 and TD6 to visual colors obtained from the grayscale measurements on the sections S4, S5 and S6, as the defined temperatures TD1, TD2 and TD3 assigned to the visual colors obtained from the grayscale measurements on the sections S1, S2 and S3, during the same operating cycle of the machine and at the time of transfer of the item blank 10′ from the parison device 13 to the finishing device 14 on the sections in question. Obviously, the pyrometers 31 could be arranged on the sections S4 and S6 instead of the sections S1 and S3, with a similar result from previously inferring therefrom the defined temperature TD4, then the defined temperatures TD1, TD2 and TD3. Obviously, the principle would remain the same with a different number of sections, as for the sections S1 to S12 on the IS machine 9 of FIGS. 5 and 6, the sections S1 to S6 being arranged symmetrically with the sections S7 to S12, relative to a median plane PM and the pyrometers 31 being for example arranged on the end section S1 and on the central section S6, an additional pyrometer 31 optionally being capable of being arranged on the intermediate section S3 to the sections S1 and S6 in order to refine the determination of the defined temperatures TD2 and TD5 on the sections S2 and S5. As above, these pyrometers 31 are only required during the database acquisition phase on the processing unit 34.

In FIG. 13, only one section is equipped with a pyrometer 31, all the sections S1 to S6 being equipped with an NIR camera 30. For example, as represented schematically in this FIG. 11, a pyrometer 31 is arranged on the parison device 13 of the intermediate section S2, making it possible to assign a defined temperature TD2 to a visual color obtained from the grayscale measurement on the section S2 during an operating cycle of the machine and at the time of transfer of the item blank 10′ of the parison device 13 to the finishing device 14 on this section S2, then inferring therefrom the defined temperatures TD1 and TD3 assigned to the visual colors obtained from the grayscale measurements on the sections S1 and S3 during the same operating cycle of the IS machine 9 and at the time of transfer of the item blank 10′ from the parison device 13 to the finishing device 14 on these sections S1 and S3, considering that the actual temperature evolves according to a temperature gradient between the section S1 and S3 linked with the variation in length of the passages 7 supplying these sections S1 to S3. On the same principle as for FIG. 11, the microprocessor 35 is programmed to subsequently assign the same defined temperatures TD4, TD5 and TD6 to visual colors obtained from the grayscale measurements on the sections S4, S5 and S6, as the defined temperatures TD1, TD2 and TD3 assigned to the visual colors obtained from the grayscale measurements on the sections S1, S2 and S3, over the same operating cycle of the machine and at the time of transfer of the item blank 10′ from the parison device 13 to the finishing device 14 on the sections in question. Obviously, the pyrometer 31 could be arranged on another of the sections S1, S3, S4, S5, S6 by applying the same principle. Obviously, the principle would remain the same with a different number of sections, as for the sections S1 to S12 on the IS machine 9 of FIGS. 5 and 6, the sections S1 to S6 being arranged symmetrically with the sections S7 to S12, relative to a median plane PM and the pyrometer 31 being for example arranged on an intermediate section S3 or S4. As above, this pyrometer 31 is only required during the database acquisition phase on the processing unit 34.

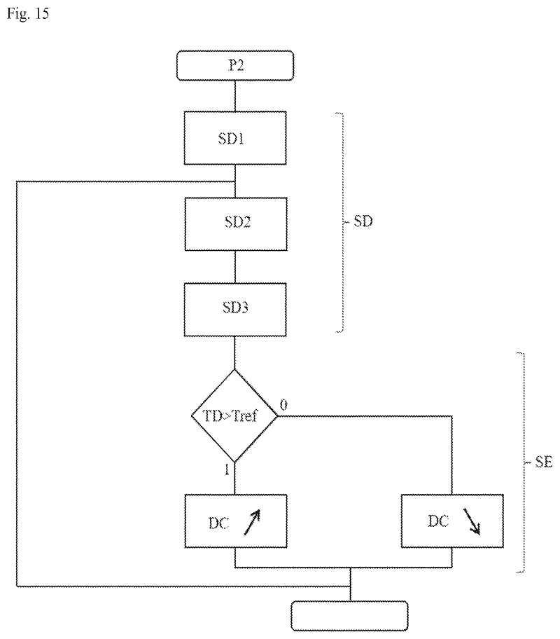

Once the database BD has been compiled by the processing unit 34, the latter may implement a second inspection and regulation phase P2 on the sections 8 of the IS machine 9, represented schematically in FIG. 15. In a fourth step SD, for each of the sections 8 of the IS machine 9, the microprocessor 35 performs the acquisition (SD2) of the measurements in real time of the grayscales on the cavities 18, 19 of the two parts 16, 17 and, preferably on the plungers 24, 25, on each parison device 13 in the open position by means of the NIR cameras 31. Then, the microprocessor 35 computes corrective data DC by comparing (SD3) the visual colors corresponding to said measured grayscales and to with defined temperatures TD are assigned, to one or more reference temperatures Tref at points or zones located on the cavities 18, 19 of the two parts 16, 17 and, preferably, on the plungers 24, 25, this or these reference temperatures being previously set (SD1) on the system 29 by means of a digital interface 36 of the processing unit 34. In a fifth step SE, when the corresponding visual color representative of a defined temperature value TD is greater than the reference temperature Tref set at a point or a zone of one of said cavities 18, 19 or of the plungers 24, 25, the processing unit 34 sends a corrective data item DC for acting upon the flap 28 of the cooling device for the parison device 13 in question in order to increase the speed of the air flow to reduce the temperatures of the cavities 18, 19 of the parison mold 13, or act upon the flap (not illustrated) of the device for cooling the plungers 24, 25 to reduce their temperatures. When the corresponding visual color is representative of a defined temperature value TD less than the reference temperature Tref set at a point or a zone of one of said cavities 18, 19 or of the plungers 24, 25, the processing unit 34 sends a corrective data item DC for acting upon the flap 28 of the cooling device for the parison device 13 in question in order to decrease the speed of the air flow to increase the temperatures of the cavities 18, 19 of the parison device 13, or act upon the flap (not illustrated) of the device for cooling the plungers 24, 25 to increase their temperatures.

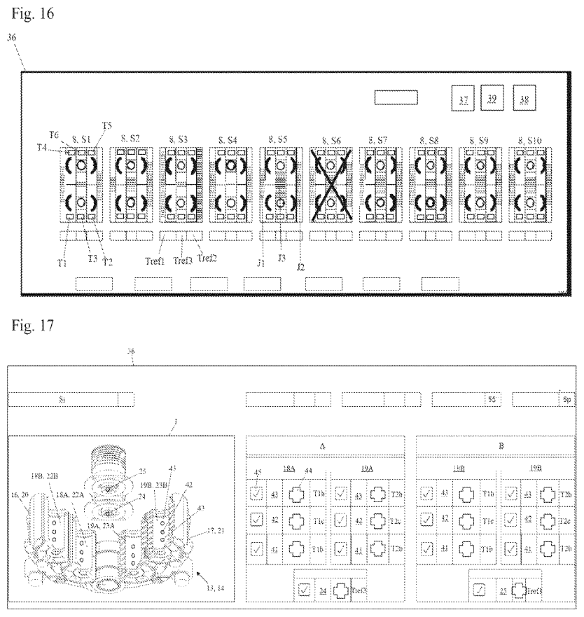

FIGS. 16 and 17 illustrate the digital interface 36 for viewing the operating status and the temperatures on the sections 8 of the IS machine 9 and also make it possible to set on each of the sections 8, the reference temperatures Tref on the cavities 18, 19 of the parts 16, 17 of the parison devices 13 and the plungers 24, 25.

In FIG. 16, the digital interface 36 allows the display of the parison devices 13 on all the sections 8. In this FIG. 16, the IS machine 9 comprises ten sections S1 to S10, instead of six or twelve as described above. Based on the grayscale measurements made by the NIR cameras 30 on the parison devices 13 and a comparison to the visual colors in the database to which defined temperatures Td correspond, the microprocessor 35 determines the temperatures T1, T2, T3 respectively on the negatives 18A, 19A and the plunger 24 located on the rear side of the parison device 13 and, similarly, the temperatures T4, T5, T6 respectively on the negatives 18B, 19B and the plunger 25 located on the front side of said parison device 13. The digital interface 36 also indicates the reference temperatures Tref1, Tref2, Tref3 configured on the cavities 18, 19 and on the plungers 24, 25 of the parison device 13, which are used by the processing unit 34 in order to vary the air flow generated on the cavities 18, 19 of the two parts 16, 17 and on the plungers 24, 25. The digital interface 36 comprises for all the sections S1 to S10 viewed on the screen of the gauges J1, J2, J3 indicating the ventilation flow percentages used to cool the cavities 18, 19 and the plungers 24, 25 on each of the parison devices 13. According to the percentage indications on these gauges J1, J2, J3 and in the case of saturation indicated by an indicator 37 for the cavities 18, 19 and by an indicator 38 for the plungers 24, 25, the operator on the IS machine 9 in order to increase the speed of the main fan (not illustrated) of the IS machine 9 regarding the parts 16, 17 and increase the cooling pressure regarding the plungers 24, 25. The processing unit 34 also performs a comparison of the temperatures T1, T2 on the rear side (negatives 18A-19A of the rear parison mold) of the parison device 13, respectively to the temperatures T4, T5 on the front side (negatives 18B-19B of the front parison mold) of said parison device 13, or performs a comparison between the mean of the temperatures T1, T2 and the mean of the temperatures T4, T5 and, in the case of a difference in temperature preferably greater than 10° C., triggers an imbalance indicator 39 allowing the operator to work on the IS machine 9 to replace the ventilation stacks modifying the air flow on the parts 16, 17 of the parison device 13, because the system 29 is unable to compensate the temperature imbalance between the front parison mold and the rear parison mold sufficiently. Instead of modifying the ventilation stacks, the processing unit may also shift the ventilation time over time in order to ventilate later or earlier and, thus, balance the temperatures on the front parison mold and on the rear parison mold.

The processing unit 34 also makes it possible to detect a malfunction on one of the sections 8 of the IS machine 9 by analyzing the grayscale measurements of the NIR cameras 30 on the sections 8, in particular when the gob 6 does not fall correctly into the funnel 40 during loading step E1 (illustrated in FIG. 2) and induces a hot spot and an accumulation of molten glass on the parison device 13, around the funnel 40. The microprocessor 35 compares the grayscales to the visual colors and when they are not listed in the database and are abnormally high and prolonged, emits an alert on the interface 36 signaling the malfunction on the section S6 in question for example with a cross (see FIG. 16) and optionally an audio signal. The processing unit 34 may also communicate directly with the IS machine 9 by means of a communication interface which may be a connection bus or a transmitter/receiver device.

The microprocessor 35 is also programmed to make it possible to set on the digital interface 36 the desired reference temperatures Tref1, Tref2, Tref3 on the cavities 18, 19 of the parts 16, 17 and the plungers 24, 25 for each parison device 13 on the sections S1 to S10. With regard to FIG. 17, the digital interface 36 makes it possible to display a section 8 of the IS machine 9 and select the reference temperatures Tref on the cavities 18, 19 and the positions of these reference temperatures Tref on these cavities 18, 19, in the top part 41 (see setpoint temperatures T1h and T2h), in the central part 42 (see setpoint temperatures Tlc and T2c) and/or in the lower part 43 (see setpoint temperatures Tlb and T2b), and also select the reference temperature Tref3 on the plungers 24, 25, thanks to joystick buttons 44 and to validation buttons 45. This setting operation is carried out on the digital interface 36, on the negatives 18A, 19A and the plunger 24 of the rear side of the parison mold 13 and on the negatives 18B, 19B and the plunger 25 of the front side of the parison device 13, for each of the sections S1 to S10 of the IS machine 9.

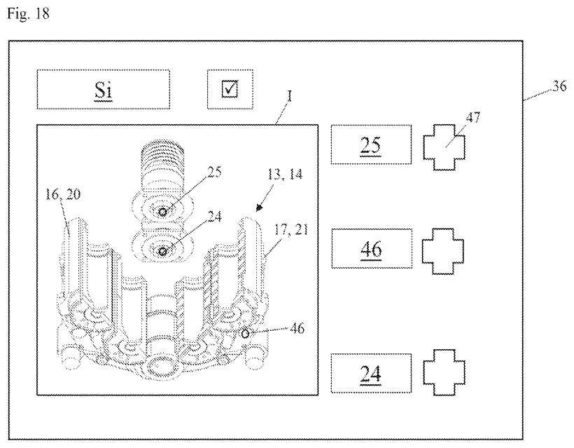

The NIR cameras 30 are attached by means of supports 32 on a structure 33 of the IS machine 9, as specified above. Their attachment positions not being identical from one parison device to another, the grayscale measurements carried out may therefore vary from one NIR camera to the other. For this, the processing unit 34 provides the option of carrying out on the digital interface 36 a calibration of each NIR camera 30 on the parison devices 13. With reference to FIG. 18, based on a grayscale measurement on the parison device 13 of a section Si, the operator may perform a calibration of the image I of the parison device 13 in the open position, by locating on the plungers 24, 25 and on a reference point 46 on one of the mold parts 16, 17 by means of the calibration buttons 47. This makes it possible advantageously to also be able to perform a recalibration of the NIR cameras 30 during use without requiring intervention of the operator on the IS machine 9, during the operation thereof.

It is also possible to provide a variant of the system 29 and the process according to the invention without using pyrometers 31 to perform the acquisition of the database of visual colors corresponding to defined temperatures on the parison devices 13 in the open position. In this case, the microprocessor 35 of the processing unit 34 may for example be programmed using an empirical method, by compiling an experimental base which will be reused in the system 29 for new applications, i.e. on IS machines 9 of other installations 1, for manufacturing other items 10, while remaining within the scope of the invention.

The process and the system 29 described hereinabove and applicable to the parison devices 13 may also be implemented in an equivalent way on the finishing devices 14 by equipping the sections 8 of the machine with second NIR cameras and with one or more second pyrometers, the pyrometer(s) then being positioned as mentioned above for the pyrometer(s) 31 with reference to FIGS. 1 and 11 to 13, i.e. so as to be placed on the sections 8 facing the opening angle of the two parts 20, 21 of the finishing device 14 in order to suitably view the negatives 22A, 22B, 23A, 23B of the cavities 22, 23 forming the finishing molds. These second pyrometers could be replaced by other temperature measurement members, for example temperature probes.

When a corrective data item is sent by the processing unit 34, the latter sends in parallel an instruction to a blowing nozzle 48 to eject the defective items 10 disposed on the conveyor 11 when they pass in front of said blowing nozzle 48, the defective items 10 then being discharged into a bunker (not illustrated) with a view to their recycling.

Preferably, the NIR cameras 30 on the side of the parison devices 13 (similarly for the second NIR cameras on the side of the finishing molds 14) are equipped with a shutter 49 reducing passage of the camera beam which makes it possible retain optimum visibility throughout the measurements while limiting infiltrations of dust and other dirt capable of adhering to the lens of this camera. The same will apply for the second NIR cameras on the side of the finishing devices 14, in the presence thereof.

The presence of the NIR cameras 30 on the sections 8 makes it possible additionally to use them in the visible range in order to perform an automatic visual inspection on the parison devices 13 and their respective environments. The processing unit 34 includes for this a database of reference images of a parison device 13 and its environment on a section 8 and is programmed to compare the images acquired in the visible range to this database of reference images and inspect whether the shapes/images of the parison device 13 and its environment are correct. In the case of detection of an anomaly, i.e. a difference between the acquired images and the reference images, the processing unit 34 triggers a shutdown of the section 8 in question on the IS machine 9 and alerts the operator on the digital interface 36. The videos captured by these NIR cameras 30 may additionally be viewed by an operator on the digital interface 36. Such a visual inspection will also be possible on the finishing devices 14, in the presence of second NIR cameras on the sections 8 of the IS machine 9. The operator may thus work on a section 8 of the IS machine 9 if the system 29 detects an anomaly on one of said sections 8. Such a visual inspection may also be implemented on the item blanks 10′ once the parison device 13 is open, or on the items 10 once the finishing device 14 is open.

The system 29 may also carry out, additionally, an inspection of the item blanks 10′ by means of the NIR cameras 30 present on the sections 8 of the IS machine 9. In this case, the system 29 operates in the same way as for the inspection of the parison molds of the parison devices 13. The NIR cameras 30 retrieve for the processing unit 34 grayscales measured on the item blanks 10′, once the parison devices 13 are in the open position and before the transfer of the item blanks 10′ to the finishing devices 14, i.e. between steps E3 and E4, the item blanks 10′ being held-rings 26 positioned at the bottom-by the ring molds 15, as illustrated in FIG. 3. The processing unit 34 then also comprises a database of visual colors corresponding to defined temperatures on the item blanks 10′. As above, the processing unit 34 then retrieves corrective data making it possible to act upon the devices for cooling the parison devices 13, this time according to the grayscales measured in real time by the NIR cameras 30 on the item blanks 10′ and at least one reference temperature on said item blanks 10′, said reference temperature being set on said system 29. In the same way as above, the processing unit 34 is preferably configured to compile the database of visual colors of an item blank 10′ by performing a correlation between grayscales measured by the NIR cameras 30 on the item blanks 10′ and a measured actual temperature and by assigning a visual color of the item blank 10′ corresponding to a defined temperature. In this preferred case, the pyrometer(s) 31 present on the parison device(s) 13 and described above, may be configured to retrieve actual temperatures of the item blank(s) 10′, the computer processing unit 34 then being configured to perform a correlation between the grayscales measured by the NIR cameras 30 on the item blanks 10′ and the actual temperature(s) measured by the pyrometer(s) 31 and assign a visual color to an item blank 10′ at a defined temperature. In the case of action on the device for cooling a parison device 13 to reduce or, conversely, increase the temperature of the parison molds, the defective item blank 10′ will also be ejected by activating the blowing nozzle 48, as above.

1. A system for inspecting and regulating on sections of a machine for forming hollow glass items, referred to as IS machine, each section having a parison device which includes two parts forming at least one parison mold, the two parts being capable of switching from an open position where they are moved apart in order to open the at least one parison mold and allow the release of the blank of the item from said at least one parison mold, to a closed position where the two parts are joined to form the at least one parison mold and allow the formation of at least one item blank, each of said parison devices having a device for cooling its two parts, the system includes a computer processing unit configured to retrieve corrective data making it possible to act upon the devices for cooling the parison devices, the system comprising the same number of cameras for measuring near infrared radiation, referred to as NIR cameras, as sections on the IS machine, the NIR cameras being placed directly on the sections with an orientation facing the parison devices making it possible to view the negatives of the parts in the open position, said NIR cameras retrieving grayscales measured on the at least one parison mold of each parison device, the processing unit including a database of visual colors corresponding to defined temperatures on the parison devices in the open position, said processing unit subsequently retrieving said corrective data according to the grayscales measured in real time by the NIR cameras on the parison devices in the open position and at least one reference temperature set on said system.

2. The system according to claim 1, wherein the computer processing unit is configured to compile the database of visual colors by performing a correlation between the grayscales measured by the NIR cameras on the parison devices in the open position and a measured actual temperature and by assigning a visual color corresponding to a defined temperature.

3. The system according to claim 2, further comprising at least one temperature measurement member associated with least one of the parison devices, said at least one temperature measurement member being configured to retrieve an actual temperature at a reference point on the parison device with which it is associated, the computer processing unit being configured to perform a correlation between the grayscales measured by the NIR cameras on the parison devices in the open position and the actual temperature measured by the at least temperature measurement member and assign a visual color to a defined temperature on the parison devices in the open position.

4. The system according to claim 3, further comprising several temperature measurement members respectively retrieving actual temperatures at a reference point on the parison devices with which they are associated, the computer processing unit being configured to perform a correlation between the grayscales measured by the NIR cameras and the actual temperatures measured by said temperature measurement members and assign a visual color to a defined temperature on at least the negatives of the parts of the parison molds.

5. The system according to claim 1, wherein each of said parison devices comprises at least one plunger and a device for cooling the at least one plunger, the computer processing unit being configured to retrieve corrective data making it possible to act upon the devices for cooling the at least one plunger, the NIR cameras also making it possible to view the at least one plunger between the two mold parts in the open position and retrieve grayscales measured on said at least one plunger, the processing unit comprises a database of visual colors corresponding to defined temperatures on the at least one plunger of the parison devices in the open position, said processing unit being configured to subsequently retrieve said corrective data for the device for cooling the at least one plunger according to the grayscales measured in real time by the NIR cameras on the plunger(s) and a reference temperature set on said system.

6. The system according to claim 5, wherein the computer processing unit is configured to compile the database of visual colors by performing a correlation between the grayscales measured by the NIR cameras on the plungers of the parison molds of the parison devices in the open position and a measured actual temperature and by assigning a visual color corresponding to a defined temperature.

7. The system according to claim, wherein the measured actual temperatures are obtained by means of at least one temperature measurement member associated with at least one of the parison devices, these actual temperatures being measured at a reference point on the parison device.

8. The system according to claim 1, wherein the computer processing unit is configured to analyze the grayscales measured by the NIR cameras and detect an abnormally high and prolonged temperature representative of an anomaly on the parison device, said processing unit emitting an item of alert and/or emergency shutdown information in respect of the section in question.

9. The system according to claim 1, wherein each section of the IS machine comprises a finishing device which includes two parts forming at least one finishing mold and is capable of switching from an open position where the two parts are moved apart to position at least one item blank or remove at least one finished item, to a closed position where the two parts of joined for the formation of at least one finished item, the finishing device comprising a device for cooling said two parts, the computer processing unit being configured to retrieve corrective data making it possible to act upon the devices for cooling the finishing devices, said system further comprising the same number of second cameras for measuring near infrared radiation, referred to as second NIR cameras, as sections on the IS machine, said second NIR cameras being placed directly on the sections with an orientation facing the finishing devices making it possible to view the negatives of the two parts of the finishing device in the open position, said second NIR cameras retrieving grayscales measured on the negatives of the two parts of the finishing devices, the computer processing unit comprising a database of visual colors corresponding to defined temperatures on the finishing devices in the open position, the computer processing unit being configured to subsequently retrieve corrective data according to the grayscales measured in real time by the second NIR cameras on the finishing devices and at least one second reference temperature set on said system.

10. The system according to claim 1, wherein each NIR camera comprises a housing equipped with a shutter for protecting a lens of said NIR camera.

11. The system according to claim 1, wherein the computer processing unit is configured to control a device for ejecting the hollow glass items at the output of the sections of the IS machine when retrieving corrective data.

12. The system according to claim 1, wherein the NIR cameras are configured to also view the at least one item blank between the two parts of each parison device in the open position and retrieve grayscales measured on said at least one item blank, the computer processing unit comprising a database of visual colors corresponding to defined temperatures on the at least one item blank, said processing unit being configured to subsequently retrieve said corrective data for the device for cooling the corresponding parison device according to the grayscales measured in real time by the NIR cameras on the at least one item blank and a reference temperature set on said system.

13. The system according to claim 1, wherein the NIR cameras are configured to retrieve images of the parison devices and their respective environments in the visible range, the processing unit of said system being configured to compare these images acquired in the visible range to a database of reference images and perform an automatic inspection of the shapes/images of the parison device in order to detect anomalies and trigger a shutdown of the section in question on the IS machine.

14. A machine for forming hollow glass items, referred to as IS machine, comprising sections each including a parison device and a finishing device, the parison device comprising at least one plunger and two parts forming at least one parison mold and capable of switching from an open position where the two parts are moved apart to open the at least one parison mold to a closed position where the two parts are joined to form the at least one parison mold, the finishing device comprising two parts forming at least one finishing mold and capable of switching from an open position where the two parts are moved apart to open the at least one finishing mold to a closed position where the two parts are joined to close the at least one finishing mold, each of said parison devices comprising a device for cooling the two parts and a device for cooling the at least one plunger, each of said finishing devices comprising a device for cooling the two parts, said IS machine comprising an inspection and regulation system having the features of claim 1.

15. The IS machine according to claim 14, wherein each cooling unit comprises a flap for varying a cool air flow generated by a fan, the computer processing unit managing the activation of said flap for varying the cool air flow according to the corrective data.

16. The IS machine according to claim 14, which comprises a device for ejecting the glass items manufactured, the computer processing unit being configured to activate said ejection device when corrective data are sent and representative of a potential manufacturing defect of the hollow glass item.

17. A process for inspecting and regulating the sections of a machine for forming hollow glass items, referred to as IS machine, each section comprising a parison device which includes two parts forming at least one parison mold and is capable of switching from an open position where the two parts are moved apart to open the at least one parison mold to a closed position where the two parts are joined to close the at least one parison mold, each of said parison devices comprising a device for cooling the two parts, said process comprising:
a step SD of measuring in real time the grayscales on each parison device in the open position by means of the NIR cameras placed directly on the sections with an orientation making it possible to view the negatives of the parts of the parison devices in the open position and computing corrective data by comparing visual colors corresponding to said grayscales to at least one reference temperature, said visual colors being assigned to defined temperatures and obtained from a database;
a step SE of activating the devices for cooling the parison devices according to the corrective data.

18. The process according to claim 17, which comprises prior steps of acquiring the database of visual colors corresponding to defined temperatures on the parison devices in the open position, said process further comprises at least:
a step SA of acquiring the grayscales measured on the negatives of the two parts of each parison device by NIR cameras placed directly on the sections with an orientation making it possible to view the negatives of the two parts of the parison devices in the open position;
a step SC of correlation between the grayscales measured by the NIR cameras and at least one measured actual temperature and assigning a visual color to a defined temperature on the parison devices.

19. The process according to claim 18, wherein the prior steps of acquiring said database comprise a step SB of acquiring the at least one actual temperature at a reference point on at least one of the parison devices, said at least one actual temperature being measured by at least one temperature measurement member, in particular of the pyrometer type, associated with said parison device, simultaneously with the step SA.

20. The process according to claim 19, wherein the step SB carries out the acquisition of actual temperatures at a reference point on several of the parison devices by means of several temperature measurement members associated with said parison devices, and the step SC carries out a correlation between the grayscales measured by the NIR cameras and the actual temperatures measured by said temperature measurement members and assigns a visual color to a defined temperature on the negatives of the two parts of the parison devices.

21. The process according to claim 17, further comprising:
analyzing the grayscales measured by the NIR cameras and detecting an abnormally high and prolonged temperature representative of an anomaly on the parison device, and
emitting an item of alert and/or emergency shutdown information in respect of the section in question.

22. The process according to claim 17, further comprising ejecting the glass items at the output of the sections of the IS machine when corrective data are retrieved for the devices for cooling the parison devices.

23. The process according to claim 17, further comprising:
measuring in real time the grayscales on at least one item blank present on each parison device in the open position by means of the NIR cameras; and
computing corrective data by comparing visual colors corresponding to said grayscales of the item blanks to at least one reference temperature, said visual colors being assigned to defined temperatures and obtained from the database.
